(19) United States
(12) Patent Application Publication
(10) Pub. No.: US 2007/0094381 A1
(43) Pub. Date: Apr. 26, 2007

(54) Methods and systems for developing a capacity management plan for implementing a network service in a data network

(76) Inventors: Walter E. Weiss, Douglasville, GA (US); Troy C. Meuninck, Newnan, GA (US)

Correspondence Address: MERCHANT & GOULD BELLSOUTH CORPORATION, P.O. BOX 2903, MINNEAPOLIS, MN, 55402, US

(21) Appl. No.: 11/257,435

(22) Filed: Oct. 24, 2005

(51) Int. Cl. G06F 15/173

(52) U.S. Cl. 709/224

(57) ABSTRACT

Methods and systems are provided for developing a capacity management plan from performance and topology information relating to the implementation of a network service in a data network. The data network includes a group of network management functions and a computer database for storing forecast reports which include performance and topology information for implementing the network service. A capacity management function is utilized to define a capacity model for the presentation of the data relating to the implementation of the network service, retrieve the data from the computer database, create a capacity plan based on the forecast reports to manage capacity for the network service, and periodically review the capacity plan at predetermined intervals to analyze the accuracy of the forecast reports and determine whether to update the capacity plan.

### BACKGROUND

Modern data networks enable service providers to offer a variety of network services to subscribers. For example, a telecommunications network may provide subscribers Internet access by offering Digital Subscriber Line (“DSL”) service which may be utilized for data communications (e.g., for sending e-mail and browsing web sites) and voice communications using Voice over Internet Protocol (“VoIP”). In offering network services to a large group of subscribers, service providers engage in capacity management and planning activities to ensure that there is adequate capacity to support the offered services. Often, network services are defined with performance characteristics and targets, such as bandwidth.

For example, to provide DSL service to a large number of subscribers, a service provider could guarantee that bandwidth (e.g., 256 kilobits per second upstream and 1.5 megabits per second downstream) for communications would always be available for each user. This guarantee however, would cost the service provider a significant amount of money in bandwidth that would normally not be used (i.e., every user would not use all of the allocated bandwidth all of the time) which would be passed on to subscribers. Since most subscribers would be unwilling to pay what it actually costs to provide guaranteed continuous bandwidth for a network service, service providers typically use an oversubscription model based on the assumption that not everyone will need or use their bandwidth at the same time. However, there is a balance between how many customers a service provider can support on a given network and how much they can charge for that network. In particular, as the number of subscribers increases, the amount of bandwidth available to each subscriber decreases as subscribers contend for bandwidth. At some point, performance will degrade so that customers are not happy with their service leading them to seek alternatives. The determination of how many customers can be supported with acceptable performance (i.e., bandwidth) on a network is one current model used by service providers for managing capacity in a network.

However, bandwidth capacity management models suffer from several drawbacks. One drawback is that the numbers of customers which may be supported in a network are based on expected or estimated user profiles and usage patterns for a particular service. Thus, if user behavior is different than expected or usage patterns change over time, the designed capacity will be wrong and performance will degrade. Another drawback with bandwidth capacity management models is that they fail to take into account the physical resources for providing network services. For example, Digital Subscriber Line Access Modules (“DSLAMs”) are used to provide DSL service to customers in a network. However, DSLAMs are limited in the number of customers that can physically be attached. Thus, once the physical capacity of a DSLAM is reached, new customers cannot be added even if there is available bandwidth in a network. Still yet another drawback with bandwidth capacity management models is that they fail to adequately take into account actual performance measures of a network service. For example, certain network services such as VoIP are extremely susceptible to delay due to “bursty” data traffic in which a large amount of data is communicated over a short time period resulting in reduced performance. Most measurement tools used by bandwidth capacity management models measure bandwidth as an average over a relatively long time period (e.g., every five minutes or in some cases every fifteen minutes) compared to the duration of a burst. As a result, short data bursts which may adversely affect certain types of data traffic often go undetected. Similarly, measurement tools used by bandwidth capacity management models also fail to take into account the numbers of discarded packets in a network if the average bandwidth is below the maximum available. As a result, a reduction in data throughput levels guaranteed by Quality of Service (“QoS”) requirements associated with network services often go undetected until reported by a customer.

### BRIEF SUMMARY

In accordance with the present invention, the above and other problems are addressed by methods and systems for developing a capacity management plan from performance and topology information relating to the implementation of a network service in a data network. A capacity management function is utilized to define a capacity model for the presentation of the data relating to the implementation of the network service, create a capacity plan based on forecast reports to manage capacity for the network service, and periodically review the capacity plan at predetermined intervals to analyze the accuracy of the forecast reports and determine whether to update the capacity plan.

According to one aspect of the invention, a method is provided for developing a network capacity management plan from performance and topology information relating to the implementation of a network service in a data communications network. The method includes defining a capacity model for the presentation of data relating to the implementation of the network service. The data is utilized for modeling and forecasting capacity in the data communications network. The method further includes receiving the data from a management system by electronically retrieving the data from a centralized computer database accessible by a plurality of network management functions in the data communications network. The retrieved data includes forecast reports including performance and topology information for implementing the network service. The method further includes electronically creating a capacity plan based on the forecast reports to manage capacity for the network service and periodically reviewing the capacity plan at predetermined intervals to analyze the accuracy of the forecast reports and determine whether to update the capacity plan.

Other aspects of the invention may be implemented among a group of networked computer systems in a data network. The networked computer systems may correspond to various management functions for managing a data network including marketing and product development, engineering, database, network, and element management systems, capacity management, infrastructure provisioning, business provisioning, budget, and management. These and various other features, as well as advantages, which characterize the present invention, will be apparent from a reading of the following detailed description and a review of the associated drawings.

### BRIEF DESCRIPTION OF THE SEVERAL VIEWS OF THE DRAWINGS

FIG. 1 is a network diagram illustrating a communications network architecture that serves as an illustrative operating environment for the present invention;

FIG. 2 is a simplified block diagram illustrating a capacity management system, according to an embodiment of the present invention; and

FIG. 3 is a flow diagram showing an illustrative routine for developing a network capacity management plan for a network service offered in the communications network of FIG. 1, according an embodiment of the present invention.

### DETAILED DESCRIPTION

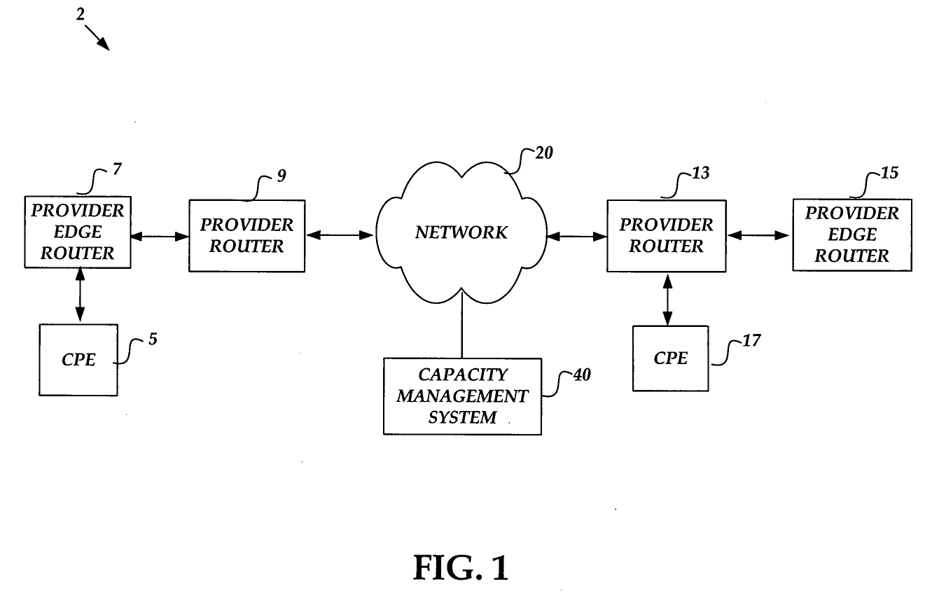

Referring now to the drawings, in which like numerals represent like elements, various aspects of the present invention will be described. In particular, FIG. 1 and the corresponding discussion are intended to provide a brief, general description of a suitable network environment in which embodiments of the invention may be implemented.

Embodiments of the present invention may be generally employed in a networked environment 2 as shown in FIG. 1. The networked environment 2 includes a data network 20 in communication with provider edge routers 9 and 13 and customer premises equipment (“CPEs”) 5 and 17. It should be understood that the data network 20 may comprise a wide area computing network such as the Internet. It should also be understood that in one illustrative embodiment of the present invention, the networked environment 2 is an Internet Protocol/Multiprotocol Label Switched (“IP/MPLS”) based network for communicating data, voice, and video for a variety of applications, including, but not limited to, VoIP, IP-based video, and Internet web page data. As is known to those skilled in the art, the MPLS standard enables IP-based networks to improve IP data packet exchange by prioritizing the communication of IP data packets in a data network based on the type of data. For example, VoIP data packets require a minimum amount of end-to-end latency (i.e., delay) and jitter and thus may be assigned a higher priority than other Internet data traffic in an IP/MPLS network.

It will be appreciated by those skilled in the art that the networked environment 2 is not limited to an IP-based network but may also include frame relay networks, asynchronous transfer mode (“ATM”) networks, or any other network capable of communicating data conforming to Layers 2-4 of the Open Systems Interconnection (“OSI”) model developed by the International Standards Organization, incorporated herein by reference. It will further be appreciated that the MPLS standard may also be utilized with any of the aforementioned networks.

As is known to those skilled in the art, the provider edge routers 9 and 13 in the networked environment 2 serve to connect (e.g., route IP data packets) the CPEs 5 and 17 to the data network 20. It should be understood that the networked environment 2 may include additional devices (not shown) for routing data, including, but not limited to provider routers, telephony switches, and digital subscriber line access multiplexers (“DSLAMs”). The CPEs 5 and 17 may include, but are not limited to, modems (e.g., DSL modems), telephones (e.g., VoIP telephones), and gateways.

A capacity management system 40 includes a number of network functions for managing capacity of the various network devices utilized to communicate data from a source to a destination in the networked environment 2. As defined herein, capacity includes performance information (i.e., the performance of network resources necessary to handle a specified load) as well as topology information (i.e., the physical and logical resources available to support provisioning for the specified load). In particular, performance information may include threshold information related to the ability of network devices to handle a certain number of customers without degradation in service. It will be appreciated by those skilled in the art that the threshold information may include such data as bandwidth, prioritization, processor utilization, and memory constraints. For instance, network devices may be provisioned so that certain customer data (e.g., VoIP data) is given priority over other data in order to satisfy quality of service (“QoS”) requirements for an offered service. As a result, priority data packets may be assigned to an expedited forwarding (“EF”) class, in which the packets are guaranteed to be delivered to their destination on time and with minimal jitter, while non-priority data packets may be assigned to a “best effort” class, in which the packets are not guaranteed. However, if too many customers are given priority over a common data link, then performance may be degraded (i.e., capacity exceeded) as result of network devices overusing resources for guaranteeing priority.

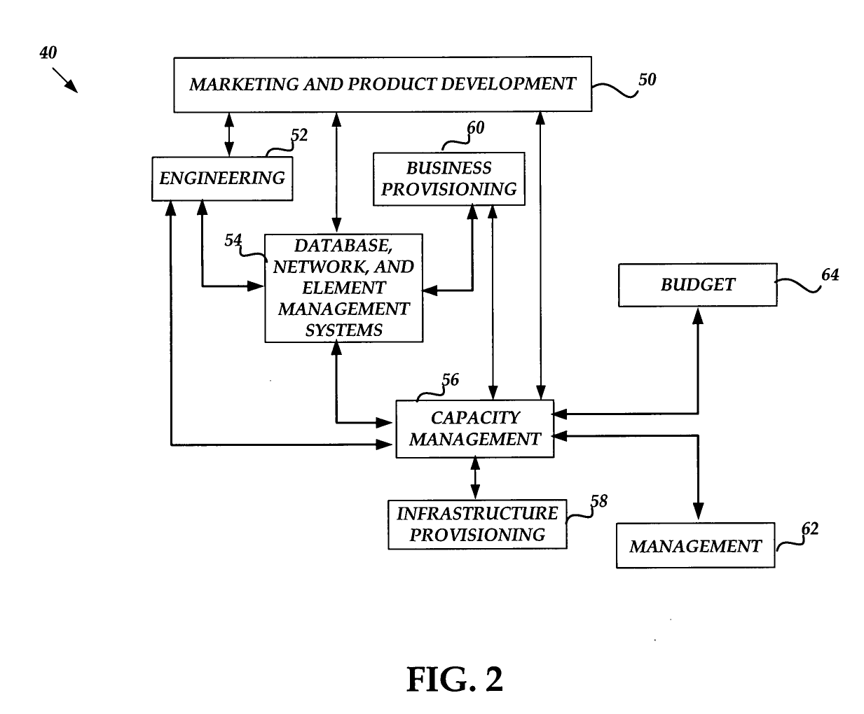

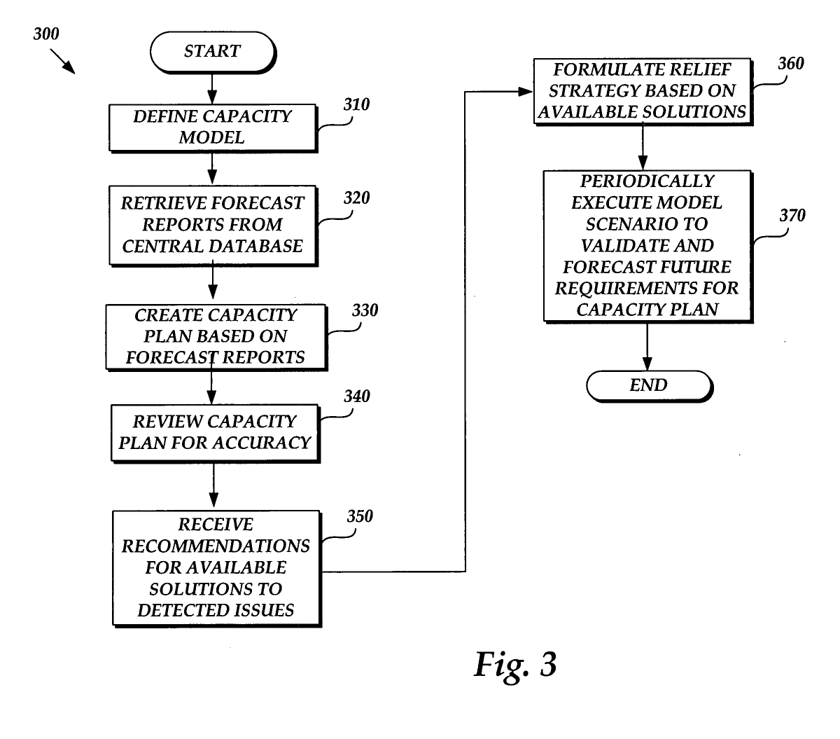

It will be appreciated by those skilled in the art that the topology information may include the number of physical and logical connections on a network device for providing a service. Based on topology information, a network device exceeds capacity if the device is unable to support any additional users. In illustrative embodiments of the present invention, the capacity management system 40 utilizes performance and topology information to create, monitor, and if necessary, update a capacity management plan for a network. The various functions of the capacity management system 40 will be discussed in greater detail below with respect to FIGS. 2-3.

FIG. 2 is a simplified block diagram illustrating the capacity management system 40, according to illustrative embodiments of the present invention. It should be understood that the capacity management system 40 includes various functions performed by a network service provider in managing a communications network. It will be appreciated that each of the functions described with respect to FIG. 2 may be implemented in a networked computer system having at least a processor, a memory, and a data store for performing various aspects of capacity management in the networked environment 2. It will be understood by those skilled in the art that one or more of the aforementioned networked computer systems may be connected to other networked computer systems via communications links over a local area network (“LAN”) or over the Internet.

The capacity management system 40 includes a marketing and product development function 50, an engineering function 52, a database, network, and element management systems function, 54, a capacity management function 56, an infrastructure provisioning function 58, a business provisioning function 60, a management function 62, and a budget function 64. Each of the aforementioned functions making up the capacity management system 40 will be described in greater detail below.

The marketing and product development function 50 includes a number of sub-functions which may include developing a business requirement, providing sales and marketing forecasts, and providing a marketing recommendation. In developing a business requirement, the marketing and product development function 50 determines products or services to be sold by a network service provider. Services may be defined based on data of what customers wish to purchase and what other vendors are doing. Sales and marketing forecasts may be provided as inputs to the capacity management process to assist in forecasting demand. Marketing recommendations are provided in response to capacity being unavailable due to some unforeseen reason or a service being undelivered due to some problem. The marketing recommendations may include solutions which would be most palatable to the customer.

The engineering function 52 includes a number of sub-functions which may include developing a service definition, providing metrics, providing standards and guidance, providing technical recommendations, and reengineering existing solutions. In developing a service definition, the engineering function 52 may collaborate with the marketing and product development function 50 to determine how a service may be offered. After a service definition is agreed upon, the engineering function 52 may determine how to best deliver the service using existing resources or if no adequate resources available, which resources would be needed to provide the service. In addition, the components which will be used to provide the service, the numbers of each required component, and the recommended minimum and maximum limits for each component are defined as it relates to defined service. If one component or device supports multiple services, the engineering function 52 determines how the services interact as well as the impact on device capacity.

The engineering function 52 also establishes metrics for determining what is “normal” operation for a service and the components that support that service. The metrics are monitored by the engineering function 52 to ensure adequate capacity and service performance. The metrics may include resource costs, service performance, device performance, and a correlation matrix. In particular, the resource costs metric may measure how much of a resource is needed to provide a service. The resource may be a card in a router, a queue on an interface, a route in a routing table, or any kind of resource that is depleted because more services have been provisioned. For instance, a new frame relay customer will need a physical port to terminate on, a data link connection identifier (“DLCI”) for the logical termination, an IP Address, some form of routing protocol, and some amount of capacity. All of these resources can be audited and tracked as they are used.

The engineering function 52 may also provide service performance metrics which define how a network service is supposed to perform and quantifies what is good service performance and what is bad service performance. In particular, upon initial deployment of a network service, the devices providing the support may be underutilized. Over time as customers are added more resources will be used resulting in decreasing performance. At some point performance will be unacceptable and more resources will have to be added.

The engineering function 52 may also provide device performance metrics which measure how various components or devices affect service delivery. In particular, when service performance has degraded to a point where additional capacity or resources must be added there must be some method to determine which component or components need to be upgraded. Each device has its own individual limits where it operates satisfactorily and a point where it can no longer support the addition of any other services. The device performance metrics monitor network devices to identify problems before they become service impacting. The engineering function 52 may also provide a correlation matrix for communicating to the capacity management function 56, which devices affect service performance.

The engineering function 52 may also provide standards and guidance with respect to providing network services. In particular, the engineering function 52 defines the normal operating ranges for designed systems provides recommendations on how to configure the systems and generic principles for alleviating problems. It will be appreciated that this guidance may be used to determine what to do as system loading increases.

The engineering function 52 may also provide technical recommendations with respect to providing network services. In particular, the engineering function 52 provides technical recommendations on alleviating a capacity shortfall with respect to providing a network service. For instance, the engineering function 52 may recommend moving customers, changing routing, and temporarily reallocating resources from one area to another.

The engineering function 52 may also reengineer solutions for providing a network service. In particular, the engineering function 52 may alleviate a capacity shortfall by designing another solution or reengineering portions of an existing solution.

The database, network, and element management systems function 54 include a number of sub-functions which may include instrument metric collection, collecting data, storing data, correlating data, presenting data, and updating service metrics. It should be understood that in one embodiment of the present invention, the database, network, and element management systems function 54 includes a centralized computer database (i.e., a central data store) for storing and correlating data related to a network service. It should be appreciated that the centralized computer database may be accessible by the other network functions in the capacity management system 40 via a computer network.

In providing the instrument metric collection function, the database, network, and element management systems function 54 may receive recommendations from the engineering function 52 at to what metrics should be polled, how often they should be polled and how they should be correlated. The database, network, and element management systems function 54 then determines how to store metric data so that it can be used by other functions in the capacity management system 40.

The database, network, and element management systems function 54 also determines how to collect data (and the best source of collecting data) related to providing a network service. In particular, the database, network, and element management systems function 54 may determine whether to collect data directly from a device or from a network management system (“NMS”)/element management system (“EMS”) monitoring that device. The database, network, and element management systems function 54 also may determine a common data dictionary to define how to handle similar data and may arrange connectivity to the appropriate systems and/or devices to get the required data.

The database, network, and element management systems function 54 also stores collected data where it is accessible to all systems requiring the data. In particular, and as briefly discussed above, the collected data may be stored in a centralized computer database. The database, network, and element management systems function 54 also insures the integrity of the stored data for the length of time it is necessary to maintain it.

The centralized computer database in the database, network, and element management systems function 54 may also automatically correlate the stored data and provide statistical probabilities about capacity forecasts and customer usage patterns. After the data has been correlated and processed it may be presented in the form of a report so that the topology of the network may be determined. The presented data may also be used by the capacity management function 56 to define a capacity data model. The database, network, and element management systems function 54 may also update the metrics used to monitor a service or device because of new usage patterns or hardware upgrades.

The infrastructure provisioning function 58 includes a number of sub-functions which may include providing technical recommendations, providing resource recommendations, installing and configuring hardware, and making configuration changes. The infrastructure provisioning function 58 provides technical recommendations based on existing knowledge of particular problem. Resource recommendations are provided based on current resource loading and when an assigned portion of a relief strategy may be accomplished. Hardware may be installed and configured when infrastructure upgrades are required. If core infrastructure needs to be reconfigured, i.e. routing distribution changes, deployment of new global configurations, upgrade of router software versions, etc., then the infrastructure provisioning function will make those changes.

The business provisioning function 60 includes a number of sub-functions which may include provisioning services for a network service, making service inquiries, providing technical recommendations, and providing resource recommendations. The business provisioning function 60 provisions network services. It should be understood that as network services are provisioned, resource tables in the centralized computer database are depleted. Furthermore, as moves, additions, changes, or deletions to resources providing network services are accomplished, the resource tables in the centralized computer database are updated to reflect these actions. The business provisioning function 60 may generate service inquiries to determine if a service is available or if capacity is available to terminate a service. These inquiries may determine if a resource is available and reserve capacity for the resource. The business provisioning function 60 updates the centralized computer database with service inquiry information so that the capacity model defined by the capacity management function 56 (discussed below) may use it for predicting capacity depletion rates. The business provisioning function 60 also provides technical and resource recommendations based on existing knowledge of a particular problem.

The budget function 62 provides financial recommendations by providing guidance with regard to available funds for reconfiguring a network or other network change. The budget function 62 balances existing financial constraints against marketing and technical requirements to determine financial solutions to capacity issues.

The management function 65 provides strategic vision for a capacity relief decision. The management function determines important markets and identifies products and/or services for investing money and time based on the likely utilization of the products and/or services in the future.

The capacity management function 56 serves to develop a network capacity management plan from performance and topology information relating to the implementation of a network service. As will be described in greater detail with respect to FIG. 3, the capacity management function 56 utilizes the marketing and product development function 50, the engineering function 52, the database, network, and element management systems function 54, the infrastructure provisioning function 58, the business provisioning function 60, the management function 62, and the budget function 64 in developing a capacity management plan.

FIG. 3 is a flow diagram showing an illustrative routine 300 performed by the capacity management function 56 for developing a network capacity management plan from performance and topology information relating to the implementation of a network service. The routine 300 begins at operation 310, where capacity management function 56 defines a capacity model. In particular, the capacity management function 56 utilizes data concerning metrics provided by the engineering function 52 to the centralized computer database in the database, network, and element management systems function 54 to model and forecast capacity for a network service. The capacity management function 56 uses the capacity model to forecast capacity requirements and project depletion before it occurs. It should be understood that that the forecast capacity requirements are saved in the centralized computer database in the database, network, and element management systems function 54 which generates forecast reports.

The routine 300 continues from operation 310 at operation 320, where the capacity management function 56 retrieves the forecast reports from the centralized computer database in the database, network, and element management systems function 54. The routine 300 then continues from operation 320 at operation 330, where the capacity management function 56 creates a capacity plan for a network service based on the forecast reports.

The routine 300 continues from operation 330 at operation 340, where the capacity management function 56 reviews the capacity plan for accuracy by analyzing current reports related to the performance of a network service generated by the database, network, and element management systems function 54 and stored in the centralized computer database, for trends and compare the trends against the capacity plan over a predetermined time period, such as a year. Exception reports (i.e., reports not matching the capacity plan) will require analysis to determine why capacity or performance is varying from the projection in the capacity plan. It will be appreciated that variations may be caused by a number of factors including, but not limited to, changes in user usage patterns, special offers and promotions, and end of month or end of year cycles. It should be understood that when a problem is detected in either the overall capacity plan or from exception reporting and an issue has been identified then additional data correlation may be necessary to determine the root cause of the deviation. It should be appreciated that the capacity management function 56 may consult the engineering function 52, the infrastructure provisioning function 58, and the business provisioning function 60 for guidance to determine the root cause of the problem.

The routine 300 continues from operation 340 at operation 350, where the capacity management function 56 receives recommendations for available solutions to detected issues. In particular, the capacity management function may utilize the received recommendations to determine a resolution that meets network balance. Network balance represents the best choice based on all available information. This information includes strategic direction, expediency, cost, effectiveness of the solution, how fast the solution must be developed, and other factors. In arriving at a resolution which meets network balance, the capacity management function 56 may receive recommendations from a number of network functions including the management function 62, the budget function 64, the engineering function 52, the infrastructure provisioning function 58, and the marketing and product development function 50.

The routine 300 continues from operation 350 at operation 360, where the capacity management function 56 formulates a relief strategy based on the available solutions determined for a network service issue. In particular, the capacity management function 56 determines what hardware will be needed, new bandwidth requirements, reconfiguration parameters, whether re-engineering is necessary, and changes to existing service performance levels for a network service.

The routine 300 continues from operation 360 at operation 370, where the capacity management function 56 periodically executes a model scenario to validate and forecast future requirements for the capacity management plan. In particular, the capacity management function 56 may periodically run the model scenario to validate how capacity is performing compared to the projections from the capacity plan. The capacity management function 56 may also use the model to forecast capacity requirements in the near term (e.g., three to six months) and the long term (e.g., six months to a year). It will be appreciated that the capacity management function 56 may also model “what-if” scenarios. For instance, a “what-if” scenario might be modeled if it is determined that the marketing and product development function 50 intends to offer a promotion on a certain service. Using marketing estimates, a model could be created to determine if there is capacity to support the promotion or where there would be shortfalls. The routine 300 then ends.

It should be understood that the capacity management function 56 may periodically review projections in a capacity plan and forecast how much capacity and where that capacity will be needed. The capacity plan may also be used for budgeting purposes. Over the course of a year the plan may be reviewed to compare projected requirements with actual requirements and adjustments may be made as required.

Based on the foregoing, it should be appreciated that the various embodiments of the invention include methods and systems for developing a capacity management plan from performance and topology information relating to the implementation of a network service in a data network. A capacity management function is utilized to define a capacity model for the presentation of the data relating to the implementation of the network service, create a capacity plan based on forecast reports to manage capacity for the network service, and periodically review the capacity plan at predetermined intervals to analyze the accuracy of the forecast reports and determine whether to update the capacity plan.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A method for developing a network capacity management plan from performance and topology information relating to the implementation of a network service in a data communications network, comprising:
defining a capacity model for the presentation of data relating to the implementation of the network service, wherein the data is utilized for modeling and forecasting capacity in the data communications network;
receiving the data from a management system by electronically retrieving the data from a centralized computer database accessible by a plurality of network management functions in the data communications network, wherein the data includes forecast reports comprising performance and topology information for implementing the network service;
electronically creating a capacity plan based on the forecast reports to manage capacity for the network service; and
periodically reviewing the capacity plan at predetermined intervals to analyze the accuracy of the forecast reports and determine whether to update the capacity plan.

2. The method of claim 1 further comprising periodically executing a model scenario based on the capacity plan to forecast future capacity requirements for the network service and validate the performance of capacity for the network service against projections in the capacity plan.

3. The method of claim 1, wherein periodically reviewing the capacity plan at predetermined intervals to analyze the accuracy of the forecast reports and determine whether to update the capacity plan comprises:
analyzing current capacity reports for the network service from the centralized computer database for trend data;
comparing the trend data against the capacity plan over a predetermined time period; and
if the trend data indicates a deviation between the current capacity reports and the capacity plan, then correlating data from at least one of the plurality of network management functions to determine the cause of the deviation.

4. The method of claim 3, further comprising:
receiving recommendations from at least one of the plurality of network management functions to determine available solutions for correcting the deviation; and
formulating a relief strategy based on the available solutions.

5. The method of claim 4, wherein formulating a relief strategy based on the available solutions comprises determining the requirement of at least one of the following:
re-engineering of the network service;
providing additional hardware for implementing the network service;
reconfiguring the network service; and
changing an existing service performance level for the network service.

6. The method of claim 5, wherein re-engineering of the network service comprises instructing an engineering network management function to re-engineer a solution for correcting the deviation.

7. The method of claim 5, wherein providing additional hardware for implementing the network service comprises instructing an infrastructure provisioning function to install and configure additional hardware for implementing the network service.

8. The method of claim 5, wherein changing an existing performance level for the network service comprises instructing a management system function to update at least one service metric for providing the network service.

9. A system for developing a capacity management plan from performance and topology information relating to the implementation of a network service, comprising:
a computer database accessible by each of a plurality of network management functions, wherein the computer database stores data including forecast reports, the forecast reports comprising performance and topology information for implementing the network service; and
a capacity management function within the plurality of network management functions, the capacity management function comprising a processing system connected to the network, wherein the processing system comprises a computer, and wherein the processing system is operative to:
define a capacity model for the presentation of the data relating to the implementation of the network service, wherein the data is utilized for modeling and forecasting capacity for the network service;
retrieve the data from the computer database;
create a capacity plan based on the forecast reports to manage capacity for the network service; and
periodically review the capacity plan at predetermined intervals to analyze the accuracy of the forecast reports and determine whether to update the capacity plan.

10. The system of claim 9, wherein the processing system is further operative to periodically execute a model scenario based on the capacity plan to forecast future capacity requirements for the network service and validate the performance of capacity for the network service against projections in the capacity plan.

11. The system of claim 9, wherein the processing system in periodically reviewing the capacity plan at predetermined intervals to analyze the accuracy of the forecast reports and determine whether to update the capacity plan, is further operative to:
analyze current capacity reports for the network service from the centralized computer database for trend data;
compare the trend data against the capacity plan over a predetermined time period; and
if the trend data indicates a deviation between the current capacity reports and the capacity plan, then correlate data from at least one of the plurality of network management functions to determine the cause of the deviation.

12. The system of claim 11, wherein the processing system is further operative to:
receive recommendations from at least one of the plurality of network management functions to determine available solutions for correcting the deviation; and
formulate a relief strategy based on the available solutions.

13. The system of claim 12, wherein the processing system in formulating a relief strategy based on the available solutions is further operative to determine the requirement of at least one of the following:
re-engineering of the network service;
providing additional hardware for implementing the network service;
reconfiguring the network service; and
changing an existing service performance level for the network service.

14. The system of claim 13, wherein if the processing system determines re-engineering of the network service is required, the processing system is further operative to instruct an engineering network management function in the plurality of network management function to re-engineer a solution for correcting the deviation.

15. The system of claim 13, wherein if the processing system determines providing additional hardware for implementing the network service is required, the processing system is further operative to instruct an infrastructure provisioning function in the plurality of network management functions to install and configure additional hardware for implementing the network service.

16. The system of claim 13, wherein if the processing system determines providing changing an existing service performance level additional hardware for the network service is required, the processing system is further operative to instruct a management system function in the plurality of network functions to update at least one service metric for providing the network service.

17. A method for developing a capacity management plan for implementing a network service in a data network, comprising:
defining a capacity model for the presentation of data relating to the implementation of the network service, wherein the data is utilized for modeling and forecasting capacity in a data communications network;
receiving the data from a management system by electronically retrieving the data from a centralized computer database accessible by a plurality of network management functions in the data communications network, wherein the data includes forecast reports comprising performance and topology information for implementing the network service;
electronically creating a capacity plan based on the forecast reports to manage capacity for the network service;
analyzing current capacity reports for the network service from the centralized computer database for trend data;
comparing the trend data against the capacity plan over a predetermined time period; and
if the trend data indicates a deviation between the current capacity reports and the capacity plan, then
correlating data from at least one of the plurality of network management functions to determine the cause of the deviation;
receiving recommendations from at least one of the plurality of network management functions to determine available solutions for correcting the deviation; and
formulating a relief strategy based on the available solutions; and
periodically executing a model scenario based on the capacity plan to forecast future capacity requirements for the network service and validate the performance of capacity for the network service against projections in the capacity plan.
